(19) United States
(12) Patent Application Publication
(10) Pub. No.: US 2009/0299813 A1
(43) Pub. Date: Dec. 3, 2009

(54) SUSTAINABLE PERFORMANCE INFORMATION FOR A PROPERTY

(76) Inventors: Thomas Cody, Portland, OR (US); Renee Worme, Beaverton, OR (US); Dennis Wilde, Portland, OR (US); Anyeley Hallova, Portland, OR (US); Steve McCallion, Portland, OR (US); David Ewald, Portland, OR (US); Chelsea Vandiver, Portland, OR (US); Aura Aragan-Ball, Portland, OR (US); Insook Huh, Hillsboro, OR (US); Michael Henderson, Newberg, OR (US); Elizabeth Brown, Portland, OR (US); Sarah Mace, Portland, OR (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 12/130,720

(22) Filed: May 30, 2008

(51) Int. Cl. G06Q 10/00; G06Q 50/00

(52) U.S. Cl. 705/10

(57) ABSTRACT

Subject matter disclosed herein may relate to measuring, calculating, and/or displaying sustainable performance information for a property.

### FIELD

Subject matter disclosed herein may relate to measuring, calculating, and/or displaying sustainable performance information for a property.

### BACKGROUND

Many consumers are concerned about the environment, and may also desire to work and live in beautiful and/or comfortable spaces. Further, consumers may be interested to understand how their living and/or work spaces may impact the environment and/or the economy. Some consumers may further place a good deal of importance on environmental concerns, work and/or living conditions, and/or economic impact when making decisions regarding where to live and/or work. For example, and individual may desire to understand the environmental impact of an office building before deciding to work in that building, or the individual may desire to understand living conditions in a condominium development before making decisions regarding living in the development. Individuals may, for a variety of reasons, also desire to understand the economic impact of a building development. However, information regarding environmental impact, living conditions, and/or economic impact may be technical in nature, and therefore not readily understandable by and/or accessible to many consumers.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a block diagram of an example embodiment of a process for converting technical environmental and economic information into non-technical indicators;

FIG. 2 is a flow diagram of an example embodiment of a process for converting and displaying non-technical indicators;

FIGS. 3a-3b comprise a diagram illustrating an example display of non-technical indicators;

FIG. 4 is a block diagram of an example embodiment of a system for transmitting and displaying non-technical indicator information; and

FIG. 5 is a block diagram of an example embodiment of a computing platform.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

As discussed above, consumers may place a deal of importance on environmental concerns, working and/or living conditions, and/or economic impact when making decisions regarding where to live and/or work. However, information regarding environmental impact, living and/or working conditions, and/or economic impact may be technical in nature, and may not be readily accessible to many consumers.

The above issues may be addressed by the collection of technical and/or economic information for a property, such as, for example, a building, and by converting the technical and/or economic information into a selected, limited set of non-technical indicators. The non-technical indicators may be more readily accessible by and/or understandable to the consumer, allowing the consumer to make more informed decisions. Also, property owners and/or developers and/or operators may utilize the non-technical indicators to market their properties, and/or the non-technical indicators may be used in public relations efforts. Of course, these are merely a few examples of uses for the non-technical indicators, and the scope of claimed subject matter is not limited in this respect.

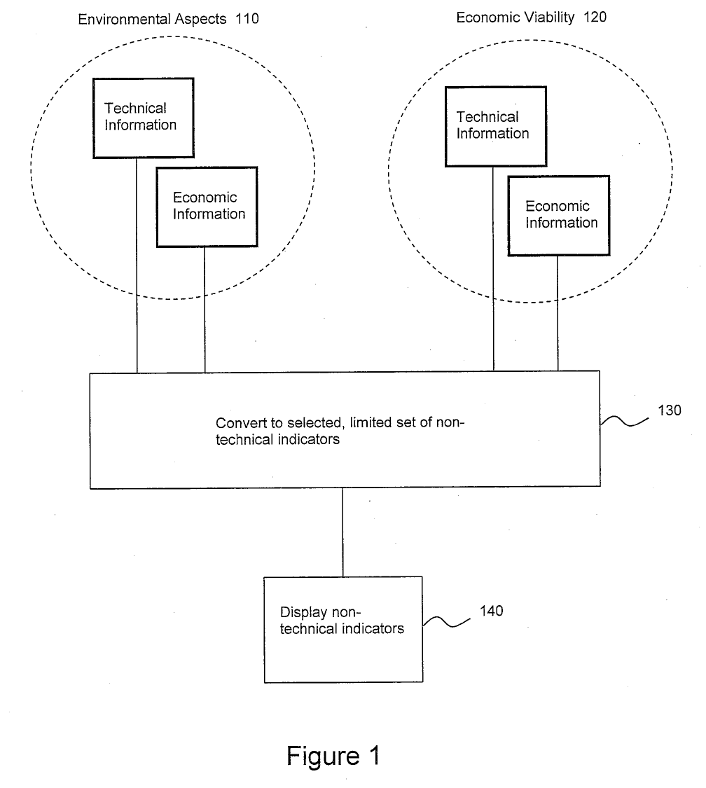

FIG. 1 is a block diagram of an example embodiment of a process for converting technical environmental and economic information into non-technical indicators. For this example embodiment, a mass of disparate technical and economic information regarding environmental aspects 110 and economic viability 120 of a building may be gathered. At block 130, the mass of disparate technical and economic information measuring environmental aspects of building utilization and building locale, and measuring economic viability of the building may be converted into a selected, limited set of non-technical indicators, and at block 140, the non-technical indicators may be displayed.

For one or more embodiments, the technical and/or economic information regarding environmental aspects of the building may include, but are not limited to, the amount of energy used, the amount of CO2 emitted, and/or the amount of water used. Other examples of technical and/or economic information that may be converted into non-technical indicators may include, but are not limited to, the types and amount of public transportation within a given range of the building, the amount and type of various amenities within walking distance of the building, the number of jobs created as a result of the building construction as well as post-construction, the amount of federal, state, and local tax revenues associated with the building development and/or operation, and/or direct, indirect, and induced economic effects associated with the building. Of course, these are merely example types of technical and/or economic information measuring environmental aspects of building utilization and building locale, and measuring economic viability, and the scope of claimed subject matter is not limited in this respect. The information for one or more embodiments may be presented to consumers in terms that they can easily understand due at least in part to relating the technical and economic information to familiar concepts such as showers, cars, homes, etc, as discussed more fully below.

For some embodiments, the technical and/or economic information may be based, at least in part, on a building design model rather than on measurements from an existing building. In some cases, technical information may be based at least in part on comparisons of the building design model with a baseline building model. Examples of non-technical indicators and how the indicators may be displayed are discussed below.

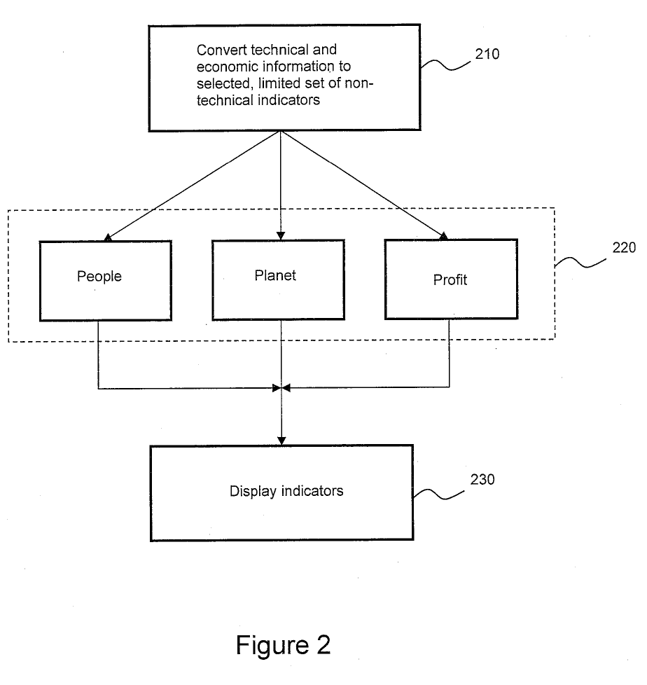

FIG. 2 is a flow diagram of an example embodiment of a process for converting and displaying non-technical indicators. As described above, the non-technical indicators may be converted from a mass of disparate technical and economic information measuring environmental aspects of building utilization and building locale, and also measuring economic viability, for one or more example embodiments. This conversion is depicted in FIG. 2 at block 210. For this example, the non-technical indicators may describe, at least in part, three aspects of the a property development. For example, one or more non-technical indicators may describe the impact of the building development on people, and one or more other non-technical indicators may describe the impact of the building development on the planet, and one or more further non-technical indicators may describe the economic impact of the building. For this example, the several areas of potential impact are depicted as people, planet, and profit, as shown at block 220. Examples of non-technical indicators in these areas are described below. Together, the three areas of potential impact of the building development may represent a triple bottom line sustainability index.

For one or more example embodiments, a triple bottom line sustainability index including non-technical indicators associated with people, place, and profit may be referred to as a “Livable Place Index™” (LPI), which is a trademark of Gerding Edlen Development Company, LLC. However, although example embodiments described herein may refer to LPI, the scope of claimed subject matter is not so limited, and other embodiments are possible that use other non-technical indicators than those depicted as associated with LPI.

The non-technical indicators may be displayed, as indicated at block 230 for this example. The non-technical indicators may be displayed in a number of ways, including, but not limited to, print media and/or electronic media. Examples of print media may include brochures, leaflets, magazine advertisements, billboards, books, cards, bookmarks, placards, A-frame advertisement boards, etc. Examples of electronic media may include electronic displays comprising and/or coupled to a computing platform, Web pages, electronic documents such as word processing documents, digital images, digital streaming video, television signals, etc. Of course, these are merely example types of print and electronic media, and the scope of claimed subject matter is not limited in these respects.

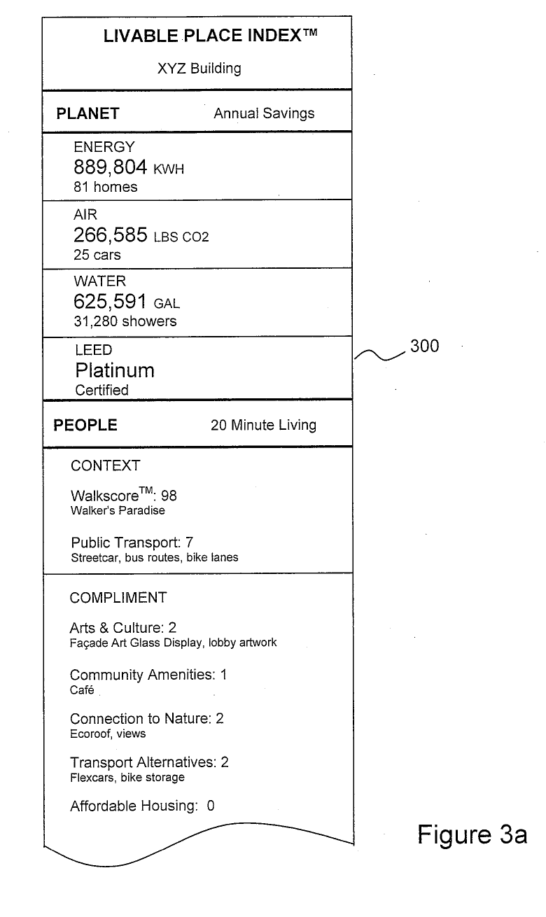

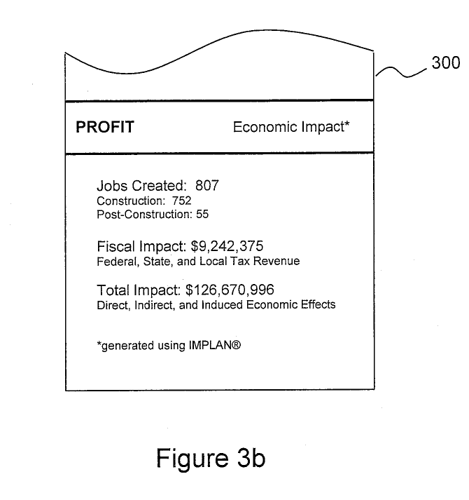

FIGS. 3a-3b comprise a diagram illustrating an example display 300 of an LPI, which, as mentioned previously, may comprise for one or more embodiments a triple bottom line sustainability index including non-technical indicators associated with people, place, and profit. The LPI for this example may be related to a fictitious building development, labeled for the purposes of this example as XYZ Building. For this example, XYZ building may comprise a single building under development. However, the scope of claimed subject matter is not limited in this respect. For example, embodiments described herein may apply to developments of more than one building, and/or may apply to one or more pre-existing buildings. For this example, XYZ building may comprise a high-rise apartment building, although again, the scope of claimed subject matter is not limited in this respect. Also for this example, LPI 300 may be displayed on an electronic sign positioned on or near the building in order to advertise some of the advantages of the building development.

As depicted in FIGS. 3a-3b, LPI 300 may be divided into three sections, labeled Planet, People, and Profit. For the Planet section, the various indicators may represent annual savings for the building as compared with a baseline building. For this example embodiment, a first non-technical indicator may comprise an Energy indicator. To generate the Energy indicator, technical information regarding the amount of electricity used and/or the amount of natural gas consumed based at least in part on a design model for the building. The total energy used according to the building design model may be compared with a total energy used by a baseline building model. For one or more embodiments, the baseline building model may represent a conventional building not implementing special features designed into the building design model. The difference in energy used annually between the building design model and the baseline model may be compare for this example with an equivalent number of homes that could be powered with the energy saved. To perform this calculation, it may be assumed that an average home consumes 10,968 kWh annually. This figure may be arrived at by averaging statistical information from the Bonneville Environmental Foundation, the US Department of Energy, and the Underwriters Laboratories, Inc. However, this is merely one example of determining the energy used for an average home, and the scope of claimed subject matter is not limited in this respect. Further, although embodiments described herein utilize an indicator of the number of homes that could be powered with the energy saved, other embodiments are possible using other non-technical indicators for the amount of energy saved.

For one specific example, the total energy saved annually for the XYZ building may be 889,804 kWh, which may be converted to a non-technical indicator of 81 homes. That is, the energy saved by implementing the energy saving features of the XYZ building would be sufficient to power 81 average homes. The figure of 81 homes is one that a typical consumer can readily understand, whereas the more technical information of 889,804 kWh saved may not be as readily understood by the typical consumer.

Another non-technical indicator for this example embodiment may comprise an AIR indicator. The Air indicator may be translated from the total pounds of CO₂ offset by the energy savings of the XYZ building project based at least in part on a Bonneville Environmental Foundation Carbon Calculator, although the scope of claimed subject matter is not limited in this respect. For this example, assume that the XYZ building is located in Oregon. The total pounds of CO₂ offset by the energy saving features of the XYZ building for this example may equal 889,804 kWh×0.2296 lbs of CO₂/kWh., which is 266,585 lbs of CO₂ annually. Also for this example, assume that an average car uses 556 gallons of gas per year, which converts to 10,833 lbs of CO₂, according to the Bonneville Environmental Foundation Carbon Calculator. Therefore, 266,585 lbs of CO₂ annually may be converted to a non-technical indicator of 266,585/10,833 cars, which may be calculated and rounded to a figure of 25 cars. In other words, the 266,585 lbs of CO₂ not emitted due to the energy saving features of the XYZ building may be the equivalent of the amount of CO₂ that would not be emitted if 25 cars were to be taken off of the roadways. A typical consumer can readily understand the impact of taking 25 cars off of the roads, while the typical consumer may not be as readily able to understand the impact of the more technical measures. The above process for generating a non-technical indicator for carbon offsets is merely one example technique, and the scope of claimed subject matter is not limited in these respects. For example, other carbon calculators may be used rather than the Bonneville calculator mentioned above. Still further, although one or more example embodiments described herein utilize the number of cars taken off of the road as a non-technical indicator of the amount of CO2 not emitted, the scope of claimed subject matter is not limited in these respects, and other embodiments are possible utilizing other non-technical indicators to represent the amount of CO2 not emitted.

An additional non-technical indicator in the Place section may comprise a WATER indicator. For this non-technical indicator, the total water saved annually according to the building design model may be converted into an equivalent number of showers taken. The total amount of water saved annually may be determined by calculating daily uses, flow rates, usage, and number of occupants for a daily volume, and the daily volume figure may be annualized. The total amount of water saved may equal the total amount used by the baseline building model subtracted by the total amount used by the building design model. For this example, it may be assumed that the total amount of water saved annually for the XYZ building is 625,591 GAL. It may also be assumed for this example that an average shower consumes 20 GAL of water. Therefore, the total amount of water saved annually may be converted into an equivalent non-technical indicator of 31,280 showers per year. While a typical consumer may not be able to readily understand the more technical measures, the consumer can readily understand the impact of saving enough water for 31,280 showers. Although example embodiments described herein utilize a number of showers per year as a non-technical indicator of the amount of water saved, the scope of claimed subject matter is not limited in this respect, and other embodiments are possible utilizing other non-technical indicators for the amount of water saved.

For this example embodiment, the Planet section of the LPI may include a Leadership in Energy and Environmental Design (LEED) indicator. The LEED rating system is administered by the U.S. Green Building Council. The LEED rating system is a third party certification program for the design, construction, and operation of high performance green buildings. For this example, the fictitious XYZ building is assumed to have been accorded a “Platinum” rating. Of course, the LEED rating system is merely an example of an additional indicator that may provide a consumer with non-technical information regarding a property's environmental performance, and the scope of claimed subject matter is not limited in this respect. Further, in one or more embodiments, an indication of the number of LEED certified properties owned, developed, and/or managed by a property developer, owner, and/or operator may be displayed as part of LPI 300. Further, in one or more embodiments, such a display regarding other LEED certified properties may include a breakdown of the number of Platinum certified properties, Gold certified properties, Silver certified properties, etc. owned, developed, and/or managed by the property developer, owner, and/or operator. Again, these are merely examples of non-technical indicators, and the scope of claimed subject matter is not limited in this respect.

Although not depicted in LPI 300, another possible non-technical indicator that may be included in the “Planet” section of LPI 300 is an indication of the amount of money saved by way of the energy saved. Again, this is merely an example indicator, and the scope of claimed subject matter is not limited in this respect.

As mentioned previously, LPI 300 for this example embodiment may comprise a “People” section. This section, for this example, may include a variety of non-technical indicators related to the building's location, as well as indicators related to culture and community amenities. One element of the People section may involve a concept that may be referred to as “20 minute living”. In general, this concept considers a variety of elements that may contribute to a “livable” place in the area immediately surrounding the building in question. Such elements may include schools, parks, retail establishments, museums, theatres, housing, post offices, and transportation alternatives, to name but a few examples, in an area surrounding the building.

In the People section, one or more non-technical indicators may be referred to as belonging to a “context” sub-section. “Context” for this example refers to amenities and such forth that are pre-existing around the building site. In contrast, a “Compliment” section that is discussed below refers to amenities and/or other elements that may be added to the area in and around the building as part of the project development. One example non-technical indicator in the Context sub-section may comprise a “Walkscore™”. A Walkscore is a metric provided by a website www.walkscore.com, where given an address, a search is made of an area around the address to determine the number of services and/or amenities within walking distance of the address. The closer the amenity or service, the higher the score. So, a large number of services and/or amenities within close walking distance may yield a high Walkscore, and a small number of services and/or amenities located at greater distances may yield a lower Walkscore. An indicator of services and/or amenities located within walking distance of a property, whether a Walkscore or some other metric, may take into account the locations of grocery stores, restaurants, coffee shops, bars, movie theatres, schools, parks, libraries, bookstores, fitness facilities, pharmacies, hardware stores, clothing stores, and music stores, to name but a few examples. Also, greater weight may be given to those services and/or amenities located closer to the building. For example, those services and/or amenities located within ¼ mile of the building may be scored the highest. However, the scope of claimed subject matter is not limited in this respect.

For the current example, it is assumed that the XYZ building is located within short walking distance of a number of services and/or amenities, and is accorded a Walkscore of 98, on a scale of 1-100. A high score such as this example score may categorize the building as a “walker's paradise”, while lower scores may categorize a building as, for example, in descending order: very walkable; some locations walkable; not walkable; and driving only. Of course, the Walkscore is merely an example technique for determining the availability of services and/or amenities in the area within walking distance of the building, and the scope of claimed subject matter is not limited in this respect. For the consumer, a non-technical indicator such as a Walkscore, for example, provides a quick and easy way to understand the general availability of services and/or amenities within walking distance of the property at question. Thus, the consumer is able to make a more informed decision with regard to the property without having to undertake a possibly burdensome investigation his or herself.

Another non-technical indicator included in the People section for this example embodiment of LPI 300 comprises a Public Transport indicator. As suggested by the title, the public transport indicator may be based at least in part on the availability of public transportation alternatives located within a specified area surrounding the building. For this example, the specified area comprises an area defined by a ¼ mile radius from the building. The types of transportation accounted for may include, but are not limited to, light rail stops, streetcar stops, subway stations, car pooling and/or sharing, bus lines, and bike lanes. For the example LPI 300, it is assumed that within ¼ of the XYZ building, there exists two bus lines, 1 street car line, and 4 bike lanes for a total score of seven. The score and an indication of the types of transportation available are noted in LPI display 300. Of course, this is merely an example technique for measuring the availability of alternative transportation, and the scope of claimed subject matter is not limited in this respect. The public transport non-technical indicator may provide the consumer With a readily understandable notion of the availability of alternative sources of transportation, and the consumer may therefore make more informed decisions regarding the property in question without needing to make a possibly burdensome inquiry him or herself.

For one or more embodiments, the Compliment sub-section of the People section may include non-technical indicators of amenities and/or other elements that may be added to the area in and around the building as part of the project development. For example LPI 300, the Compliment sub-section may include an Arts and Culture indicator. For this example, fictitious building XYZ may have art glass incorporated into the building facade, and may also have artwork added to the lobby. Thus, for this example, the XYZ building receives an Arts and Culture score of two. Other types of art and culture elements that may be taken into account for the Art and Culture non-technical indicator may include, but are not limited to, sculptures, paintings, interactive artwork, kiosks, murals, decorative street furniture, theatres, performance centers, etc. Of course, these are merely examples art and culture elements, and the scope of claimed subject matter is not limited in this respect.

The Compliment sub-section may further include a Community Amenities non-technical indicator, for this example embodiment. For this example, the XYZ building may have a cafe incorporated in or near the building, thus yielding a score of one for the Community Amenities indicator. Other example types of community amenities that may be accounted for in a Community Amenities indicator may include daycare, community centers, health centers, schools, learning centers, public tours, and/or classes. Of course, these are merely example types of community amenities, and the scope of claimed subject matter is not limited in this respect.

Another example non-technical indicator within the Compliment sub-section may comprise a Connection to Nature indicator, as depicted in LPI 300. For this example, the XYZ building is assumed to have incorporated thereon an “ecoroof”. In one embodiment, an ecoroof may comprise a vegetated roof system used in place of a conventional roof. An ecoroof may be comprised of several layers that may include a root barrier, waterproof membrane, drainage, soil system, and plants, for example. The XYZ building is also assumed to have advantageous views of nature, perhaps of hills, trees, mountains, etc., to name but a few possibilities. The ecoroof and views of nature for this example translate into a Connection to Nature score of two for the XYZ building, as depicted in LPI 300. Other example types of elements that may be accounted for in a Connection to Nature indicator may include, but are not limited to, parks, gardens, arboretums, golf courses, greenways, trail connections, bioswales, plazas, communal spaces, walking trails, eco-landscaped terraces, roof gardens, etc., to name but a few examples.

A further example non-technical indicator for the Compliment sub-section of the People section may comprise a Transport Alternatives indicator. For this example, the XYZ building is assumed to have incorporated flexcars, sometimes referred to as car sharing, and bicycle storage facilities. These two transportation alternatives provide the XYZ building with a Transport Alternatives score of two, as depicted in LPI 300. Other example transportation alternatives that may be accounted for in a Transport Alternative indicator may include, but are not limited to, light rail, streetcar, tram, bus, extensive bike parking, park-ride, hybrid car parking, etc., to name but a few examples.

For one or more embodiments, the Compliment section may comprise an Affordable Housing non-technical indicator. Such an indicator may take into account the total number of affordable and workforce housing units. For one example, low income may be defined as 60% median income, and workforce may be defined as 80-150% median income. However, these are merely examples of defining low-income and workforce housing, and the scope of claimed subject matter is not limited in this regard. For the example XYZ building, affordable housing is assumed to not be provided.

Through the use of the above non-technical indicators associated with the People section of LPI 300, consumers may receive easy-to-understand information regarding various aspects related to a “livable” location. Consumers may utilize this information in making determinations regarding the property in question, and may also utilize the information to compare with similar information from other properties. Similarly, the non-technical indicators allow property developers and/or owners and/or operators to communicate in a straight-forward way at least some of the advantages of the property to consumers, thus aiding marketing and/or public relations efforts. Further, property developers and/or owners and/or operators may utilize the non-technical indicators to gauge their own performance in implementing features leading to a “livable” property.

Turning to FIG. 3b, a continuation of LPI 300 is depicted. As mentioned previously, LPI 300 for this example may comprise a Profit section. The Profit section for one or more embodiments may include non-technical indicators related to the economic impact of a property development, such as, for example, the XYZ building. For one or more embodiments, information related to economic impact may be generated and/or analyzed using an IMPLAN® software program. IMPLAN® is a registered trademark of Minnesota IMPLAN Group, Inc. Of course, the IMPLAN program is merely an example tool that may be used in generating and/or analyzing information related to economic impact, and the scope of claimed subject matter is not limited in this respect.

Among the possible non-technical indicators that may be included in the Profit section are a Jobs Created indicator. The Jobs Created indicator may include sub-indicators for constructions jobs and post-construction jobs. For the current example of the XYZ building, it is assumed that a total of 807 jobs have been and/or are to be created. It is further assumed that 752 of those jobs are related to the construction of the XYZ building and that 55 of those jobs are post-construction jobs.

Another non-technical indicator included in the Profit section comprises a Fiscal Impact indicator. For one or more embodiments, this indicator may account for impacts on federal, state, and/or local tax revenues associated with a property and/or the development of one or more buildings. For the example XYZ building development, it is assumed that the total fiscal impact is $9,242,375, as depicted in LPI 300. Of course, this is merely an example fiscal impact figure, and the scope of claimed subject matter is not limited in this respect.

Also included in the Profit section for example LPI 300 is a Total Impact indicator. Such an indicator, for one or more embodiments, may account for direct, indirect, and induced economic effects stemming from a building development. For the example of the XYZ building, it is assumed that the Total Impact is $126,670,996, as depicted in FIG. 3b. Of course, this is merely an example Total Impact figure, and the scope of claimed subject matter is not limited in this respect.

Although the embodiments described above in connection the fictitious XYZ building contemplate Planet, People, and Profit sections, other embodiments are possible with fewer other sections, fewer sections, and/or more sections. Further, the non-technical indicators described in connection with each of the Planet, People, and Profit sections are merely examples of the types of indicators that may be utilized in one or more embodiments. Similarly, the techniques described for converting technical information and economic information into the non-technical indicators are merely example techniques, and the scope of claimed subject matter is not limited in these respects.

The non-technical indicators described herein may provide consumers with readily understandable and quickly distributable information regarding a property's impact on the environment, the property's “livable” space features, and/or the property development's economic impact. The information is presented to the consumers in terms that they can easily understand due at least in part to relating the technical and economic information to familiar concepts such as showers, cars, homes, etc. Consumers may use these indicators to make informed decisions about the property, and may use indicators from other properties to make comparisons among the properties. Further, property developers and/or owners and/or operators may use the indicators to market their properties, and/or the indicators may be used in public relations efforts. Property developers and/or owners and/or operators may also utilize the non-technical indicators to gauge their own performance in developing the properties. Consumers and developers/owners/operators may also be able to gauge a property's long-term sustainability at least in part through the non-technical indicators. For example, and LPI such as LPI 300 discussed above may provide a visual representation of a property's sustainable performance data. For one or more examples, the visual representation may comprise triple-bottom line sustainability data, which, for one or more embodiments, may comprise planet, people, and profit elements.

Although example LPI 300 is described as applying to a single building or property, claimed subject matter is not so limited, and other embodiments are possible where non-technical indicators are provided for a portfolio of properties. Also, the technical and economic information used to generate the non-technical indicators may be relatively static information, or may comprise information that is updated on perhaps a regular and/or continual basis.

For one or more embodiments, “LPI to per square root” cost ratios may be calculated and used to compare one property to another. For example, a consumer looking for a property to rent or buy may compare the LPI to per square foot cost ratios for two or more properties, and may use the resulting information in his/her decision making processes. Also, LPI to vacancy ratios and/or indicators may provide data for marketing and/or research purposes. In one or more embodiments, LPI information may be collected across property types and/or across an industry, and the LPI information may be marketed on a subscription and/or fee basis. However, these are merely examples of how non-technical indicators, including LPI, may be utilized, and the scope of claimed subject matter is not limited in these respects.

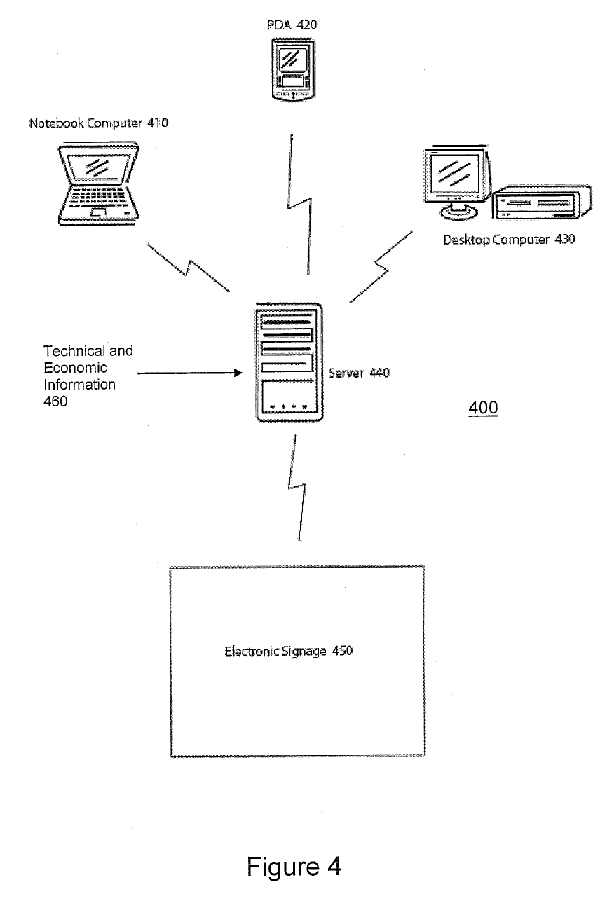

FIG. 4 is a block diagram of an example embodiment of a system 400 for transmitting and displaying non-technical indicators such as those discussed above in connection with FIGS. 1-3. System 400 for this example may comprise a server 440 that may comprise a process (not shown) to execute instructions that may enable server 440 to convert received technical and economic information 460 into a selected, limited set of non-technical indicators. Received information 460 for this example embodiment may comprise a mass of disparate technical and economic information measuring environmental aspects of building utilization and building locale, and measuring economic viability of the building. For one or more embodiments, server 440 may be enabled to convert received information 460 into an LPI, such as, for example, LPI 300, discussed above in connection with FIGS. 3a-3b.

The LPI may be transmitted by server 440 to any of a wide range of electronic devices, in one or more embodiments. System 400 for this example may comprise a notebook computer 410, a personal digital assistant (PDA) 420, a desktop computer 430, and an electronic signage device 450. Of course, this is merely an example system configuration, and the scope of claimed subject matter is not limited in this respect. For this example, server 440 may transmit the LPI to any of devices 410, 420, 430, and 450. For an embodiment, server 440 may comprise a Web server, and individuals may retrieve the LPI information by loading a web page that causes the LPI to be displayed on the receiving device. However, a Web server is merely an example function of server 440, and the scope of claimed subject matter is not limited in this respect.

For one or more embodiments, electronic signage 450 may comprise an electronic billboard that may be positioned on or near a building. Electronic signage 450 may display LPI information related to that particular building, and/or may display other information, such as LPI information from other properties or from a portfolio of properties. Further, for an embodiment, the LPI information may be periodically and/or regularly and/or continually updated by server 440 as additional and/or revised information is received or generated. For one or more embodiments, server 440 may communicate with devices 410, 420, 430, and/or 450 via a wireless network. However, the scope of claimed subject matter is not limited in this respect.

Although embodiments described herein discuss the use of electronic devices to display LPI information, other embodiments are possible utilizing print media and/or other media to disseminate LPI information. For example, rather than electronic signage for a building, an A-frame billboard may be utilized to promote a building's LPI information. Similarly, LPI information may be published in any of a range of print media formats, including, but not limited to, pamphlets, leaflets, brochures, cards, bookmarks, magazine and/or newspaper copy, books, etc., to name but a few examples.

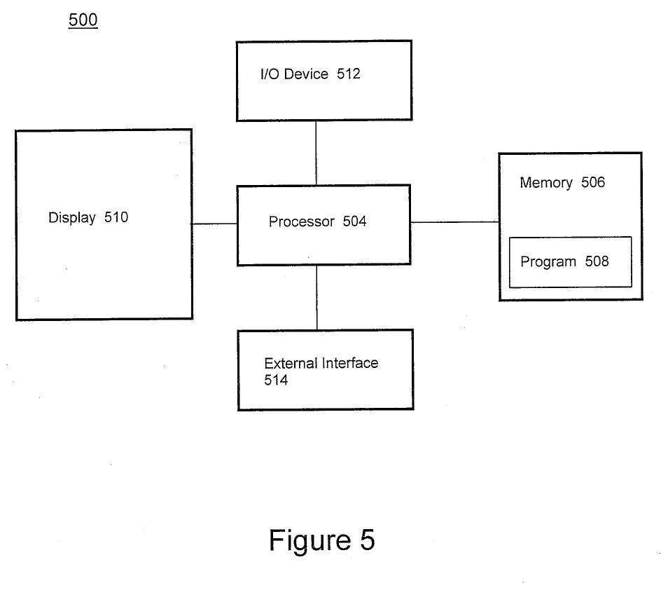

Referring to FIG. 5, a block diagram illustrates a computing platform 500 according to one or more embodiments, although the scope of claimed subject matter is not limited in this respect. Computing platform 500 may include more and/or fewer components than those shown in FIG. 5. However, generally conventional components may not be shown, for example, a battery, a bus, and so on. A computing platform such as that depicted in FIG. 5 may be utilized as a server platform to transmit non-technical indicators such as those described above, and/or may be utilized in a system including a display device such as display 510, which may, for one example, comprise an electronic sign such as electronic signage 450 discussed above. Further, a computing platform such as platform 500 may be utilized to execute instructions that may enable the computing platform to generate non-technical indicators such as those discussed above. However, these are merely examples of how computing platform 500 may be utilized, and the scope of claimed subject matter is not limited in this respect.

Computing platform 500, as shown in FIG. 5 may be utilized to tangibly embody a computer program and/or graphical user interface by providing hardware components on which the computer program and/or graphical user interface may be executed. Computing platform 500 may be utilized to tangibly embody all or a portion of the procedures of FIGS. 1-3, for example, and may represent a server platform such as server 440, for another example. Such a procedure, computer program and/or machine readable instructions may be tangibly stored on a computer and/or machine readable storage medium such as a compact disk (CD), digital versatile disk (DVD), flash memory device, hard disk drive (HDD), and so on. As shown in FIG. 5, computing platform 500 may be controlled by processor 504, including one or more auxiliary processors (not shown). Processor 504 may comprise a central processing unit such as a microprocessor or microcontroller for executing programs, performing data manipulations, and controlling the tasks of computing platform 500. Auxiliary processors may manage input/output, perform floating point mathematical operations, manage digital signals, perform fast execution of signal processing algorithms, operate as a back-end processor and/or a slave-type processor subordinate to processor 504, operate as an additional microprocessor and/or controller for dual and/or multiple processor systems, and/or operate as a coprocessor and/or additional processor. Such auxiliary processors may be discrete processors and/or may be arranged in the same package as processor 504, for example, in a multicore and/or multithreaded processor; however, the scope of claimed subject matter is not limited in these respects.

Communication with processor 504 may be implemented via a bus (not shown) for transferring information among the components of computing platform 500. A bus may include a data channel for facilitating information transfer between storage and other peripheral components of computing platform 500. A bus further may provide a set of signals utilized for communication with processor 504, including, for example, a data bus, an address bus, and/or a control bus. A bus may comprise any bus architecture according to promulgated standards, for example, industry standard architecture (ISA), extended industry standard architecture (EISA), micro channel architecture (MCA), Video Electronics Standards Association local bus (VLB), peripheral component interconnect (PCI) local bus, PCI express (PCIe), hyper transport (HT), standards promulgated by the Institute of Electrical and Electronics Engineers (IEEE) including IEEE 488 general-purpose interface bus (GPIB), IEEE 696/S-100, and so on, although the scope of claimed subject matter is not limited in this respect.

Other components of computing platform 500 may include, for example, memory 506, including one or more auxiliary memories (not shown). Memory 506 may provide storage of instructions and data for one or more programs 508 to be executed by processor 504, such as all or a portion of the procedures of FIGS. 1-4, for example. Memory 506 may be, for example, semiconductor-based memory such as dynamic random access memory (DRAM) and/or static random access memory (SRAM), and/or the like. Other semi-conductor-based memory types may include, for example, synchronous dynamic random access memory (SDRAM), Rambus dynamic random access memory (RDRAM), ferroelectric random access memory (FRAM), and so on. Alternatively or additionally, memory 106 may be, for example, magnetic-based memory, such as a magnetic disc memory, a magnetic tape memory, and/or the like; an optical-based memory, such as a compact disc read write memory, and/or the like; a magneto-optical-based memory, such as a memory formed of ferromagnetic material read by a laser, and/or the like; a phase-change-based memory such as phase change memory (PRAM), and/or the like; a holographic-based memory such as rewritable holographic storage utilizing the photorefractive effect in crystals, and/or the like; and/or a molecular-based memory such as polymer-based memories, and/or the like. Auxiliary memories may be utilized to store instructions and/or data that are to be loaded into memory 506 before execution. Auxiliary memories may include semiconductor based memory such as read-only memory (ROM), programmable read-only memory (PROM), erasable programmable read-only memory (EPROM), electrically erasable read-only memory (EEPROM), and/or flash memory, and/or any block oriented memory similar to EEPROM. Auxiliary memories also may include any type of non-semiconductor-based memories, including, but not limited to, magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and so on. Other varieties of memory devices are contemplated as well.

Computing platform 500 further may include display 510. Display 510 may comprise a video display adapter having components, including, for example, video memory, a buffer, and/or a graphics engine. Such video memory may be, for example, video random access memory (VRAM), synchronous graphics random access memory (SGRAM), windows random access memory (WRAM), and/or the like. Display 510 may comprise a cathode ray-tube (CRT) type display such as a monitor and/or television, and/or may comprise an alternative type of display technology such as a projection type CRT type display, a liquid-crystal display (LCD) projector type display, an LCD type display, a light-emitting diode (LED) type display, a gas and/or plasma type display, an electroluminescent type display, a vacuum fluorescent type display, a cathodoluminescent and/or field emission type display, a plasma addressed liquid crystal (PALC) type display, a high gain emissive display (HGED) type display, and so forth. As mentioned previously, display 510 may comprise, for one example embodiment, an electronic billboard that may be enabled to display LPI information, for example.

Computing platform 500 further may include one or more I/O devices 512. I/O device 512 may comprise one or more I/O devices 512 such as a keyboard, mouse, trackball, touchpad, joystick, track stick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, and/or the like.

Computing platform 500 further may include an external interface 514. External interface 514 may comprise one or more controllers and/or adapters to prove interface functions between multiple I/O devices 512. For example, external interface 514 may comprise a serial port, parallel port, universal serial bus (USB) port, and IEEE 1394 serial bus port, infrared port, network adapter, printer adapter, radio-frequency (RF) communications adapter, universal asynchronous receiver-transmitter (UART) port, and/or the like, to interface between corresponding I/O devices 512.

Embodiments claimed may include one or more apparatuses for performing the operations herein. These apparatuses may be specially constructed for the desired purposes, or they may comprise a general purpose computing platform selectively activated and/or reconfigured by a program stored in the device. The processes and/or displays presented herein are not inherently related to any particular computing platform and/or other apparatus. Various general purpose computing platforms may be used with programs in accordance with the teachings herein, or it may prove convenient to construct a more specialized computing platform to perform the desired method. The desired structure for a variety of these computing platforms will appear from the description below.

Embodiments claimed may include algorithms, programs and/or symbolic representations of operations on data bits or binary digital signals within a computer memory capable of performing one or more of the operations described herein. Although the scope of claimed subject matter is not limited in this respect, one embodiment may be in hardware, such as implemented to operate on a device or combination of devices, whereas another embodiment may be in software. Likewise, an embodiment may be implemented in firmware, or as any combination of hardware, software, and/or firmware, for example. These algorithmic descriptions and/or representations may include techniques used in the data processing arts to transfer the arrangement of a computing platform, such as a computer, a computing system, an electronic computing device, and/or other information handling system, to operate according to such programs, algorithms, and/or symbolic representations of operations. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities. In addition, embodiments are not described with reference to any particular programming language. It will be appreciated that a variety of programming languages may be used to implement the teachings described herein.

Likewise, although the scope of claimed subject matter is not limited in this respect, one embodiment may comprise one or more articles, such as a storage medium or storage media. This storage media may have stored thereon instructions that if executed by a computing platform, such as a computer, a computing system, an electronic computing device, a cellular phone, a personal digital assistant, and/or other information handling system, for example, may result in an embodiment of a method in accordance with claimed subject matter being executed, for example. The terms “storage medium” and/or “storage media” as referred to herein relate to media capable of maintaining expressions which are perceivable by one or more machines. For example, a storage medium may comprise one or more storage devices for storing machine-readable instructions and/or information. Such storage devices may comprise any one of several media types including, but not limited to, any type of magnetic storage media, optical storage media, semiconductor storage media, disks, floppy disks, optical disks, CD-ROMs, magnetic-optical disks, read-only memories, random access memories, electrically programmable read-only memories, electrically erasable and/or programmable read-only memories, flash memory, magnetic and/or optical cards, and/or any other type of media suitable for storing electronic instructions, and/or capable of being coupled to a system bus for a computing platform. However, these are merely examples of a storage medium, and the scope of claimed subject matter is not limited in this respect.

The term “instructions” as referred to herein relates to expressions which represent one or more logical operations. For example, instructions may be machine-readable by being interpretable by a machine for executing one or more operations on one or more data objects. However, this is merely an example of instructions, and the scope of claimed subject matter is not limited in this respect. In another example, instructions as referred to herein may relate to encoded commands which are executable by a processor having a command set that includes the encoded commands. Such an instruction may be encoded in the form of a machine language understood by the processor. For an embodiment, instructions may comprise run-time objects, such as, for example, Java and/or Javascript objects. However, these are merely examples of an instruction, and the scope of claimed subject matter is not limited in this respect.

Unless specifically stated otherwise, as apparent from the preceding discussion, it is appreciated that throughout this specification discussions utilizing terms such as processing, computing, calculating, selecting, forming, enabling, inhibiting, identifying, initiating, receiving, transmitting, determining, estimating, incorporating, adjusting, modeling, displaying, sorting, applying, varying, delivering, appending, making, presenting, distorting and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

What is claimed is:

1. A process, comprising:
converting a mass of disparate technical and economic information measuring environmental aspects of building utilization and building locale, and measuring economic viability of the building into a selected, limited set of non-technical indicators.

2. The process of claim 1, wherein said converting comprises converting information measuring building energy utilization savings into a non-technical indicator of an amount of energy saved.

3. The process of claim 2, wherein the non-technical indicator of the amount of energy saved comprises an indicator of a number of homes capable of being powered by the savings.

4. The process of claim 2, wherein said information measuring building energy utilization savings comprises a total energy used based at least in part on a design model for the building subtracted from a total energy used based at least in part on a baseline model for the building, wherein the total energy used based at least in part on the design model for the building comprises electricity used and natural gas used.

5. The process of claim 1, wherein said converting comprises converting information related to building CO2 emissions into a non-technical indicator of an amount of CO2 not emitted, wherein said information related to building CO2 emissions comprises a total amount of CO2 not emitted based at least on part on a design model for the building as compared to a baseline model for the building.

6. The process of claim 5, wherein the non-technical indicator of the amount of CO2 not emitted comprises a non-technical indicator of a number of automobiles theoretically removed from use.

7. The process of claim 1, wherein said converting comprises converting information measuring building water utilization savings into a non-technical indicator of the amount of water saved.

8. The process of claim 7, wherein the non-technical indicator of the amount of water saved comprises a non-technical indicator of a number of showers theoretically not taken.

9. The process of claim 7, wherein said information measuring building water utilization savings comprises information derived at least in part from flow rates associated with water fixtures in the building.

10. The process of claim 1, wherein said converting comprises converting information measuring land for the building developed horizontally versus vertically to an indicator of acres of land theoretically saved as compared to acres that would otherwise be utilized for a traditional development.

11. The process of claim 1, wherein said converting comprises converting information measuring environmental aspects of building locale into a context indicator and a complement indicator, wherein the context indicator comprises an indicator of services and/or amenities located within a specified radius from the building and further comprises an indicator of an amount of public transportation within an additional specified radius from the building.

12. The process of claim 11, wherein the services and/or amenities comprise one or more of a grocery store, a restaurant, a coffee shop, a bar, a movie theater, a school, a park, a library, a bookstore, a fitness center, a pharmacy, a hardware store, a clothing store, and/or a music store.

13. The process of claim 11, wherein the complement indicator comprises an indicator of additional services and/or amenities provided with the building to complement the services and/or amenities located within the specified radius of the building.

14. The process of claim 13, wherein the additional services and/or amenities comprise one or more of art and culture, community amenities, connections to nature, transportation alternatives, and/or affordable housing.

15. The process of claim 1, wherein said converting comprises converting information measuring economic viability of the building into an indicator of jobs created.

16. The process of claim 15, wherein the indicator of jobs created comprises an indicator of an estimate of jobs to be created for construction of the building and also comprises an indicator of an estimate of jobs to be created post construction.

17. The process of claim 1, wherein said converting comprises converting information measuring economic viability of the building into an indicator of fiscal impact.

18. The process of claim 17, wherein the indicator of fiscal impact comprises one or more estimates of tax revenues to be generated at the local, state, and/or federal level.

19. The process of claim 1, wherein said converting comprises converting information measuring economic viability of the building into an indicator of total economic impact, including direct, indirect, and/or induced economic effects.

20. The process of claim 1, further comprising displaying the selected, limited set of non-technical indicators to provide a visual representation of a sustainable performance of the building.

21. The process of claim 20, wherein said displaying comprises displaying the selected, limited set of non-technical indicators on an electronic display device.

22. The process of claim 20, wherein said displaying comprises displaying the selected, limited set of non-technical indicators on a print medium.

23. The process of claim 20, wherein said visual representation of the sustainable performance represents a triple bottom line sustainability related to people, planet, and profit.

24. The process of claim 1, wherein said disparate technical and economic information comprises static and real-time information.

25. The process of claim 1, further comprising converting an additional mass of disparate technical and economic information for an additional one or more buildings into the selected, limited set of non-technical indicators, wherein the building and the additional one or more buildings comprise a portfolio of properties.

26. The process of claim 1, further comprising utilizing the selected, limited set of non-technical indicators to market the building.

27. The process of claim 1, further comprising generating a plurality of ratios of non-technical indicators to costs per square foot to compare a plurality of properties for rent and/or sale.

28. An article, comprising: a storage medium having stored thereon instructions that, if executed, enable a computing platform to:
convert a mass of disparate technical and economic information measuring environmental aspects of building utilization and building locale, and measuring economic viability of the building into a selected, limited set of non-technical indicators.

29. The article of claim 28, wherein the storage medium has stored thereon further instructions that, if executed, further enable the computing platform to convert the mass of disparate technical and economic information by converting information measuring building energy utilization savings into a non-technical indicator of a amount of energy saved, wherein said information measuring building energy utilization savings comprises a total energy used based at least in part on a design model for the building subtracted from a total energy used based at least in part on a baseline model for the building.

30. The article of claim 29, wherein the non-technical indicator of the amount of energy saved comprises a non-technical indicator of a number of homes capable of being powered by the energy saved.

31. The article of claim 29, wherein the total energy used based at least in part on the design model for the building comprises electricity used and natural gas used.

32. The article of claim 28, wherein the storage medium has stored thereon further instructions that, if executed, further enable the computing platform to convert the mass of disparate technical and economic information by converting information related to building CO2 emissions into a non-technical indicator of an amount of CO2 not emitted, wherein said information related to building CO2 emissions comprises a total amount of CO2 not emitted based at least in part on a design model for the building as compared to a baseline model for the building.

33. The article of claim 32, wherein the non-technical indicator of the amount of CO2 not emitted comprises a non-technical indicator of a number of automobiles theoretically removed from use.

34. The article of claim 28, wherein the storage medium has stored thereon further instructions that, if executed, further enable the computing platform to convert the mass of disparate technical and economic information by converting information measuring building water utilization savings into a non-technical indicator of an amount of water saved.

35. The article of claim 34, where the non-technical indicator of the amount of water saved comprises a non-technical indicator of a number of showers theoretically not taken.

36. The article of claim 34, wherein said information measuring building water utilization savings comprises information derived at least in part from flow rates associated with water fixtures in the building.

37. The article of claim 28, wherein the storage medium has stored thereon further instructions that, if executed, further enable the computing platform to convert the mass of disparate technical and economic information by converting information measuring land for the building developed horizontally versus vertically to an indicator of acres of land theoretically saved as compared to acres that would otherwise be utilized for a traditional development.

38. The article of claim 28, wherein the storage medium has stored thereon further instructions that, if executed, further enable the computing platform to convert the mass of disparate technical and economic information by converting information measuring environmental aspects of building locale into a context indicator and a complement indicator, wherein the context indicator comprises an indicator of services and/or amenities located within a specified radius from the building and further comprises an indicator of an amount of public transportation within an additional specified radius from the building.

39. The article of claim 38, wherein the services and/or amenities comprise one or more of a grocery store, a restaurant, a coffee shop, a bar, a movie theater, a school, a park, a library, a bookstore, a fitness center, a pharmacy, a hardware store, a clothing store, and/or a music store.

40. The article of claim 38, wherein the complement indicator comprises an indicator of additional services and/or amenities provided with the building to complement the services and/or amenities located within the specified radius of the building and

41. The article of claim 40, wherein the additional services and/or amenities comprise one or more of art and culture, community amenities, connections to nature, transportation alternatives, and/or affordable housing.

42. The article of claim 28, wherein the storage medium has stored thereon further instructions that, if executed, further enable the computing platform to convert the mass of disparate technical and economic information by converting information measuring economic viability of the building into an indicator of jobs created.

43. The article of claim 42, wherein the indicator of jobs created comprises an indicator of an estimate of jobs to be created for construction of the building and also comprises an indicator of an estimate of jobs to be created post construction.

44. The article of claim 28, wherein the storage medium has stored thereon further instructions that, if executed, further enable the computing platform to convert the mass of disparate technical and economic information by converting information measuring economic viability of the building into an indicator of fiscal impact.

45. The article of claim 44, wherein the indicator of fiscal impact comprises one or more estimates of tax revenues to be generated at the local, state, and/or federal level.

46. The article of claim 28, wherein the storage medium has stored thereon further instructions that, if executed, further enable the computing platform to convert the mass of disparate technical and economic information by converting information measuring economic viability of the building into an indicator of total economic impact, including direct, indirect, and/or induced economic effects.

47. The article of claim 28, wherein the storage medium has stored thereon further instructions that, if executed, further enable the computing platform to display the selected, limited set of non-technical indicators to provide a visual representation of a sustainable performance of the building.

48. The article of claim 47, wherein the storage medium has stored thereon further instructions that, if executed, further enable the computing platform to display the selected, limited set of non-technical indicators by displaying the selected, limited set of non-technical indicators on an electronic display device.

49. The article of claim 47, wherein the storage medium has stored thereon further instructions that, if executed, further enable the computing platform to display the selected, limited set of non-technical indicators by displaying the selected, limited set of non-technical indicators on a print medium.

50. The article of claim 47, wherein said visual representation of the sustainable performance represents a triple bottom line sustainability related to people, planet, and profit.

51. The article of claim 28, wherein the storage medium has stored thereon further instructions that, if executed, further enable the computing platform to convert an additional mass of disparate technical and economic information for an additional one or more buildings into the selected, limited set of non-technical indicators, wherein the building and the additional one or more buildings comprise a portfolio of properties.

52. The article of claim 27, wherein the storage medium has stored thereon further instructions that, if executed, further enable the computing platform to generate a plurality of ratios of non-technical indicators to costs per square foot to enable a comparison of a plurality of properties for rent and/or sale.

53. A system, comprising:
means for converting a mass of disparate technical and economic information measuring environmental aspects of building utilization and building locale, and measuring economic viability of the building into a selected, limited set of non-technical indicators; and
means for displaying the selected, limited set of non-technical indicators.

54. The system of claim 53, wherein said means for converting comprises means for converting information measuring building energy utilization savings into a non-technical indicator of an amount of energy saved, wherein said information measuring building energy utilization savings comprises a total energy used based at least in part on a design model for the building subtracted from a total energy used based at least in part on a baseline model for the building.

55. The system of claim 54, wherein the non-technical indicator of the amount of energy saved comprises a non-technical indicator of a number of homes capable of being powered by the savings.

56. The system of claim 54, wherein the total energy used based at least in part on the design model for the building comprises electricity used and natural gas used.

57. The system of claim 53, wherein said means for converting comprises means for converting information related to building CO2 emissions into a non-technical indicator of an amount of CO2 not emitted, wherein said information related to building CO2 emissions comprises a total amount of CO2 not emitted based at least in part on a design model for the building as compared to a baseline model for the building.

58. The system of claim 57, wherein the non-technical indicator of the amount of CO2 not emitted an indicator of a number of automobiles theoretically removed from use.

59. The system of claim 53, wherein said means for converting comprises means for converting information measuring building water utilization savings into a non-technical indicator of an amount of water saved, wherein said information measuring building water utilization savings comprises information derived at least in part from flow rates associated with water fixtures in the building.

60. The system of claim 59, wherein the non-technical indicator of the amount of water saved comprises a non-technical indicator of a number of showers theoretically not taken.

61. The system of claim 53, wherein said means for converting comprises means for converting information measuring land for the building developed horizontally versus vertically to an indicator of acres of land theoretically saved as compared to acres that would otherwise be utilized for a traditional development.

62. The system of claim 53, wherein said means for converting comprises means for converting information measuring environmental aspects of building locale into a context indicator and a complement indicator, wherein the context indicator comprises an indicator of services and/or amenities located within a specified radius from the building and further comprises an indicator of an amount of public transportation within an additional specified radius from the building, wherein the services and/or amenities located within the specified radius from the building comprise one or more of a grocery store, a restaurant, a coffee shop, a bar, a movie theater, a school, a park, a library, a bookstore, a fitness center, a pharmacy, a hardware store, a clothing store, and/or a music store, wherein the complement indicator comprises an indicator of additional services and/or amenities provided with the building to complement the services and/or amenities located within the specified radius of the building, wherein the additional services and/or amenities comprise one or more of art and culture, community amenities, connections to nature, transportation alternatives, and/or affordable housing.

63. The system of claim 53, wherein said means for converting comprises means for converting information measuring economic viability of the building into an indicator of jobs created.

64. The system of claim 63, wherein the indicator of jobs created comprises an indicator of an estimate of jobs to be created for construction of the building and also comprises an indicator of an estimate of jobs to be created post construction.

65. The system of claim 53, wherein said means for converting comprises means for converting information measuring economic viability of the building into an indicator of fiscal impact comprising one or more estimates of tax revenues to be generated at the local, state, and/or federal level

66. The system of claim 53, wherein said means for converting comprises means for converting information measuring economic viability of the building into an indicator of total economic impact, including direct, indirect, and/or induced economic effects.

67. The system of claim 53, wherein said means for displaying comprises means for displaying the selected, limited set of non-technical indicators to provide a visual representation of a sustainable performance of the building.

68. The system of claim 67, wherein said visual representation of the sustainable performance represents a triple bottom line sustainability related to people, planet, and profit.

69. The system of claim 53, further comprising means for converting an additional mass of disparate technical and economic information for an additional one or more buildings into the selected, limited set of non-technical indicators, wherein the building and the additional one or more buildings comprise a portfolio of properties.

70. A computing platform, comprising:
a storage medium; and
a processor enabled by instructions stored on the storage medium to convert a mass of disparate technical and economic information measuring environmental aspects of building utilization and building locale, and measuring economic viability of the building into a selected, limited set of non-technical indicators.

71. The computing platform of claim 70, wherein the processor is further enabled to convert the mass of disparate technical and economic information by converting information measuring building energy utilization savings into a non-technical indicator of an amount of energy saved, wherein said information measuring building energy utilization savings comprises a total energy used based at least in part on a design model for the building subtracted from a total energy used based at least in part on a baseline model for the building.

72. The computing platform of claim 71, wherein the non-technical indicator of the amount of energy saved comprises a non-technical indicator of a number of homes capable of being powered by the energy saved.

73. The computing platform of claim 71, wherein the total energy used based at least in part on the design model for the building comprises electricity used and natural gas used.

74. The computing platform of claim 70, wherein the processor is further enabled to convert the mass of disparate technical and economic information by converting information related to building CO2 emissions into a non-technical indicator of an amount of CO2 not emitted, wherein said information related to building CO2 emissions comprises a total amount of CO2 not emitted based at least in part on a design model for the building as compared to a baseline model for the building.

75. The computing platform of claim 74, wherein the non-technical indicator of the amount of CO2 not emitted comprises a non-technical indicator of a number of automobiles theoretically removed from use.

76. The computing platform of claim 70, wherein the processor is further enabled to convert the mass of disparate technical and economic information by converting information measuring building water utilization savings into a non-technical indicator of an amount of water saved, wherein said information measuring building water utilization savings comprises information derived at least in part from flow rates associated with water fixtures in the building.

77. The computing platform of claim 76, wherein the non-technical indicator comprises a non-technical indicator of a number of showers theoretically not taken.

78. The computing platform of claim 70, wherein the processor is further enabled to convert the mass of disparate technical and economic information by converting information measuring land for the building developed horizontally versus vertically to an indicator of acres of land theoretically saved as compared to acres that would otherwise be utilized for a traditional development.

79. The computing platform of claim 70, wherein the processor is further enabled to convert the mass of disparate technical and economic information by converting information measuring environmental aspects of building locale into a context indicator and a complement indicator, wherein the context indicator comprises an indicator of services and/or amenities located within a specified radius from the building and further comprises an indicator of an amount of public transportation within an additional specified radius from the building.

80. The computing platform of claim 79, wherein the services and/or amenities comprise one or more of a grocery store, a restaurant, a coffee shop, a bar, a movie theater, a school, a park, a library, a bookstore, a fitness center, a pharmacy, a hardware store, a clothing store, and/or a music store, and wherein the complement indicator comprises an indicator of additional services and/or amenities provided with the building to complement the services and/or amenities located within the specified radius of the building, wherein the additional services and/or amenities comprise one or more of art and culture, community amenities, connections to nature, transportation alternatives, and/or affordable housing.

81. The computing platform of claim 70, wherein the processor is further enabled to convert the mass of disparate technical and economic information by converting information measuring economic viability of the building into an indicator of jobs created.

82. The computing platform of claim 81, wherein the indicator of jobs created comprises an indicator of an estimate of jobs to be created for construction of the building and also comprises an indicator of an estimate of jobs to be created post construction.

83. The computing platform of claim 70, wherein the processor is further enabled to convert the mass of disparate technical and economic information by converting information measuring economic viability of the building into an indicator of fiscal impact.

84. The computing platform of claim 83, wherein the indicator of fiscal impact comprises one or more estimates of tax revenues to be generated at the local, state, and/or federal level.

85. The computing platform of claim 70, wherein the processor is further enabled to convert the mass of disparate technical and economic information by converting information measuring economic viability of the building into an indicator of total economic impact, including direct, indirect, and/or induced economic effects.

86. The computing platform of claim 70, further comprising a display device coupled to the processor to display the selected, limited set of non-technical indicators to provide a visual representation of a sustainable performance of the building.

87. The computing platform of claim 86, wherein the display device comprises an electronic billboard.

88. The computing platform of claim 86, wherein the display device comprises a printing device to display the selected, limited set of non-technical indicators on a print medium.

89. The computing platform of claim 86, wherein said visual representation of the sustainable performance represents a triple bottom line sustainability related to people, planet, and profit.

90. The computing platform of claim 70, wherein said disparate technical and economic information comprises static and real-time information.

91. The computing platform of claim 70, wherein the processor is further enabled to convert an additional mass of disparate technical and economic information for an additional one or more buildings into the selected, limited set of non-technical indicators, wherein the building and the additional one or more buildings comprise a portfolio of properties.

92. The computing platform of claim 70, wherein the processor is further enabled to generate a plurality of ratios of non-technical indicators to costs per square foot to compare a plurality of properties for rent and/or sale.
